(19) United States
(12) Patent Application Publication
(10) Pub. No.: US 2012/0071269 A1
(43) Pub. Date: Mar. 22, 2012

(54) Golf Clubs With Golf Club Heads Having Grooves Formed With Textured Surfaces

(75) Inventors: Donald S. Rahrig, Mansfield, TX (US); Robert Boyd, Flower Mound, TX (US); William J. Ritchie, Fort Worth, TX (US)

(73) Assignee: Nike, Inc., Beaverton, OR (US)

(21) Appl. No.: 13/211,641

(22) Filed: Aug. 17, 2011

Related U.S. Application Data
(60) Provisional application No. 61/375,321, filed on Aug. 20, 2010.

(51) Int. Cl. A63B 53/04; B23H 5/04; B23P 17/00

(52) U.S. Cl. 473/331; 29/428; 219/69.17

(57) ABSTRACT

A golf club with a golf club head having a plurality of grooves formed using electrical discharge machining is presented. The grooves may be formed in a ball striking surface of the golf club head and may include portions having a texture. In some examples, the roughness of the texture may vary as the groove extends from the ball striking surface along a sidewall of the groove. For instance, texture formed along an edge radius of the groove extending between the ball striking surface and the sidewall may be rougher than texture extending lower along the sidewall. In some examples, portions of the sidewall and/or bottom of the groove may be void of texture.

### CROSS-REFERENCE TO RELATED APPLICATIONS

This application claims priority to co-pending provisional application Ser. No. 61/375,321, filed Aug. 20, 2010, and entitled “Golf Clubs with Golf Club Heads Having Grooves Formed with Textured Surfaces,” which is herein incorporated by reference in its entirety.

### FIELD

This invention relates generally to golf clubs. In particular, the invention relates to golf clubs having grooves formed in a front face of a golf club head, wherein the grooves may include textured surfaces. Such grooves may be formed, for example, using electrical discharge machining (“EDM”).

### BACKGROUND

The popularity of the game of golf has increased immensely in recent decades. All manner of players are looking for equipment that will improve an individual's performance, thereby making the game more enjoyable. As golf regulating bodies, such as the United States Golf Association (“USGA”), institute rules and limitations on the design, configuration, etc. of golf clubs, clubs must be designed to remain within the regulations of the ruling body, while still providing expected or improved performance.

One such regulation deals with club head grooves and their shape, size, configuration, etc. The USGA recently enacted regulations limiting the size, shape, and volume of golf club grooves, particularly for clubs having a loft angle greater than 25°. Limiting groove sizes and edge angles is expected to limit the club's ability to channel away water, grass, and other debris during a ball strike and is expected to limit or reduce the spin included on the ball by the ball strike. These features are expected to result in more inconsistent shots (particularly out of the rough). Accordingly, there is a need in the art for golf club heads having conforming grooves that have improved or more consistent performance.

### SUMMARY

The following presents a general summary of aspects of the invention in order to provide a basic understanding of the invention and various features of it. This summary is not intended to limit the scope of the invention in any way, but it simply provides a general overview and context for the more detailed description that follows.

Aspects of this invention relate to golf clubs and golf club heads having grooves formed in a ball striking surface of the front face of the golf club head. The grooves may be formed using electrical discharge machining and may be formed in various sizes, shapes, configurations, etc. In some examples, the grooves may be formed with one or more end walls meeting a bottom of the groove at a substantially 90° angle.

In some arrangements, at least some portions of at least some of the groove surfaces may include a texture. For instance, the EDM process may form a texture along at least a portion of the groove. In some examples, the texture may extend along an edge radius extending between the front face of the golf club head and a sidewall of the groove. The texture may further extend downward, along the sidewall toward a bottom of the groove. In some examples, the roughness of the texture may vary along the edge radius, sidewall, etc. For instance, texture formed along the edge radius may be rougher than texture formed along a portion of the sidewall. In some instances, at least a portion of the sidewall and/or the bottom of the groove may be void of texture.

### BRIEF DESCRIPTION OF THE DRAWINGS

A more complete understanding of the present invention and certain advantages thereof may be acquired by referring to the following detailed description in consideration with the accompanying drawings, in which:

FIG. 1 is an example golf club having a plurality of grooves formed in a ball striking surface of a front face of the club head in accordance with illustrative aspects of the invention.

FIG. 2 is a front view of an example golf club head having a plurality of grooves (shown enlarged) formed using EDM in accordance with at least some illustrative aspects of the invention.

FIG. 3A is a cross sectional view of some example grooves used as an illustrative aid to explain various terms and definitions as used in this specification.

FIG. 3B is a cross-sectional view of an example groove according to this invention, e.g., formed using EDM, having a texture region along an edge radius and a sidewall of the groove in accordance with at least some illustrative aspects of the invention.

FIG. 4A is a front view of an example groove, e.g., formed using EDM, in accordance with at least some illustrative aspects of the invention.

FIG. 4B is a perspective view of the groove of FIG. 4A in accordance with at least some illustrative aspects of the invention.

FIG. 4C is a cross sectional view of the groove of FIG. 4A taken along line 4C-4C of FIG. 4A extending from a toe of the golf club head to a heel in accordance with at least some illustrative aspects of the invention.

FIGS. 5A and 5B illustrate alternate groove configurations in accordance with at least some illustrative aspects of the invention.

FIG. 6 is an example method of forming a golf club head having grooves formed using EDM in accordance with at least some illustrative aspects of the invention.

FIGS. 7A and 7B are cross-sectional views showing different example grooves according to this invention, e.g., formed using EDM, having texture regions along some portions of the edge radius and a sidewall of the groove and/or a top surface of the ball striking face.

FIGS. 8A and 8B illustrate other example cross-sectional views of groove constructions that may be provided in accordance with at least some examples of this invention.

The reader is advised that the attached drawings are not necessarily drawn to scale.

### DETAILED DESCRIPTION

In the following description of various example structures in accordance with the invention, reference is made to the accompanying drawings, which form a part hereof, and in which are shown by way of illustration various example articles, including one or more golf club or golf club head structures. Additionally, it is to be understood that other specific arrangements of parts and structures may be utilized and structural and functional modifications may be made without departing from the scope of the present invention. Also, while the terms “top,” “bottom,” “front,” “back,” “rear,” “side,” “underside,” “overhead,” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of this invention. Further, the invention generally will be described as it relates to iron-type golf clubs. However, aspects of the invention may be used with any of several types of golf clubs, including wood-type golf clubs, hybrid type golf clubs, and the like and nothing in the specification or figures should be construed to limit the invention to use with the iron-type golf clubs described.

A. General Description of Illustrative Golf Clubs with Golf Club Heads Having Grooves with Textured Surfaces, e.g., Formed Using Electrical Discharge Machining (“EDM”)

In general, as described above, aspects of this invention relate to golf clubs or golf club head structures. More detailed descriptions of aspects of this invention follow.

1. Example Golf Clubs and Golf Club Heads Having Grooves Formed Using EDM

Aspects of this invention relate to golf club and golf club head structures. In at least some examples, the golf club head may include a golf club head body having a toe, a heel, a top or crown, a sole, a rear and a front face, the front face including a ball striking surface. The golf club head may further include a plurality of grooves formed in the ball striking surface. In some examples, one or more of the plurality of grooves may be formed to include a textured surface, e.g., using electrical discharge machining (EDM). In some arrangements, at least one groove of the plurality of grooves may have a first sidewall and a second sidewall extending inward from the front ball striking face of the golf club head body to a bottom or interior end of the groove. This groove may further include a first edge radius extending between the first sidewall and the front face and a second edge radius extending between the second sidewall and the front face (the first and second radii may be the same or different, and may be within a range of 0.0075 to 0.025 inches, and in some examples, between 0.009 and 0.21 inches or even between 0.01 and 0.02 inches). In at least some examples, at least one of the first edge radius and the second edge radius may include a first texture. In some aspects, at least a portion of the first sidewall and at least a portion of the second sidewall may include a second texture and the first texture and the second texture may have different roughnesses. For instance, in some arrangements, the first texture may be rougher than the second texture.

In at least some aspects, the first texture and the second texture may extend downward along the first sidewall and the second sidewall between 10% and 75% of the overall depth of the groove (and in some examples, between 15% and 50% or even between 20% and 30% of the overall depth of the groove). In some examples, the first texture may extend from the first edge radius along at least a portion of the first sidewall and from the second edge radius along at least a portion of the second sidewall. In at least some arrangements, the first texture may include a plurality of texture regions, each texture region having a different roughness.

Other example golf club head structures in accordance with this invention may include a plurality of grooves formed in the ball striking surface, wherein at least one groove of the plurality of grooves has a first end arranged proximate the toe and a second end arranged proximate the heel and a constant vertical depth along a length of the groove extending from the first end to the second end. In at least some examples, the groove or grooves of this type may be formed using EDM.

As noted above, at least some of the grooves on the club head body may further include a texture extending along the first sidewall and the second sidewall of the groove. In some examples, the texture may include a first texture region along the first edge radius and the second edge radius of the groove. This first texture region may have a first roughness. The texture may further include a second texture region adjacent the first texture region and extending inward from the first texture region (into the groove) along the first sidewall and the second sidewall. The second texture region may have a second roughness. The texture may further include a third texture region adjacent the second texture region and extending further inward (further into the groove) from the second texture region along the first sidewall and the second sidewall. The third texture region may have a third roughness. In at least some examples, at least a portion of the first sidewall and at least a portion of the second sidewall will be void of texture (e.g., the inward most portions of each sidewall and/or a bottom surface of the groove may have smooth surfaces). In some arrangements, the first roughness may be greater than the second roughness and the second roughness may be greater than the third roughness.

In at least some examples, the texture may further include a fourth texture region adjacent the third texture region and extending still further inward from the third texture region (still deeper into the groove) along the first sidewall and the second sidewall. In some arrangements, the fourth texture region may have a fourth roughness and the third roughness may be greater than the fourth roughness.

Still other aspects of this invention relate to golf clubs including a golf club shaft and a golf club head connected to one end of the shaft, wherein the golf club head is any of the various types described above. While aspects of this invention may be practiced on any type of golf club head (e.g., drivers, fairway woods, hybrids, and putters), in some examples, aspects of this invention will be practiced with iron type golf clubs and golf club heads. As some more specific examples, golf clubs and golf club heads in accordance with at least some examples of this invention will have a loft angle of 25° or more, and in some examples, within a range of 25° to 68°, or even within a range of 25° to 64°. Some more specific examples of this invention will include golf clubs and golf club heads having loft angles within the range of range of 45° to 64°. Also, aspects of this invention may be practiced on clubs generally known as or corresponding to 5-irons to 9-irons, pitching wedges, sand wedges, gap wedges, lob wedges, and the like.

2. Example Methods of Forming Golf Clubs and Golf Club Heads Having Textured Grooves

In at least some aspects, method of forming golf clubs and/or golf club heads may include forming a golf club head body including a toe, a heel, a top or crown, a sole, a rear and a front face, the front face including a ball striking surface. The methods may further include forming a plurality of grooves in the ball striking surface of the golf club head body using EDM. The methods may further include connecting the golf club head to a shaft. In some examples, the step of forming a plurality of grooves in the ball striking surface of the golf club head body may further include forming a texture along at least a portion of one or more of the grooves. Forming the texture may include forming a plurality of texture regions, each texture region having different texture properties. In some examples, the different texture properties may include each texture region having a different roughness from its adjacent neighboring texture region.

As some more specific examples, the first texture region may be located along an edge radius extending between the front face and a first sidewall of the groove and the first texture region may have a first roughness. Forming the plurality of grooves using EDM may further include forming a second texture region using EDM. This second texture region may be adjacent the first texture region and may extend inward from the first texture region (deeper into the groove) along the first sidewall of the groove. The second texture region also may have a second roughness different from the first roughness. In at least some arrangements, forming the first texture region and the second texture region may include forming texture along 10% and 75% of the overall depth of the groove (and in some examples, between 15% and 50% or even between 20% to 30% of the overall depth of the groove). The grooves and texturing may have any of the features and/or characteristics described above.

Additional aspects and specific examples of the articles described above will be described in detail more fully below. The reader should understand that these specific examples are set forth merely to illustrate examples of the invention, and they should not be construed as limiting the invention.

### B. Detailed Description of Example Golf Clubs, Golf Club Heads and Methods of Forming Golf Clubs and Golf Club Heads According to the Invention

Referring to the figures and following discussion, golf clubs and golf club heads in accordance with the present invention are described. As discussed above, the golf club and club head structures described herein may be described in terms of iron-type golf clubs. However, the present invention is not limited to the precise arrangements disclosed herein but applies to golf clubs generally, including wood-type clubs, hybrid clubs, wedge-type golf clubs, and the like.

Example golf club and golf club head structures in accordance with this invention may constitute iron-type golf clubs including wedge-type golf clubs, such as 5-irons through 9-irons, pitching wedges, sand wedges, gap wedges, lob wedges, etc. Aspects of this invention may be practiced on cavity back type irons, perimeter weighted irons, blade type irons, muscle back irons, and any other general iron constructions. Additionally, aspects of this invention may be practiced on long irons (e.g., 1-irons through 4-irons), driving irons, as well as on “wood-type” golf clubs and golf club heads, e.g., clubs and club heads typically used for drivers and fairway woods, as well as for “wood-type” utility or hybrid clubs, or the like. Although these club head structures may have little or no actual “wood” material, the still may be referred to conventionally in the art as “woods” (e.g., “metal woods,” “fairway woods,” etc.).

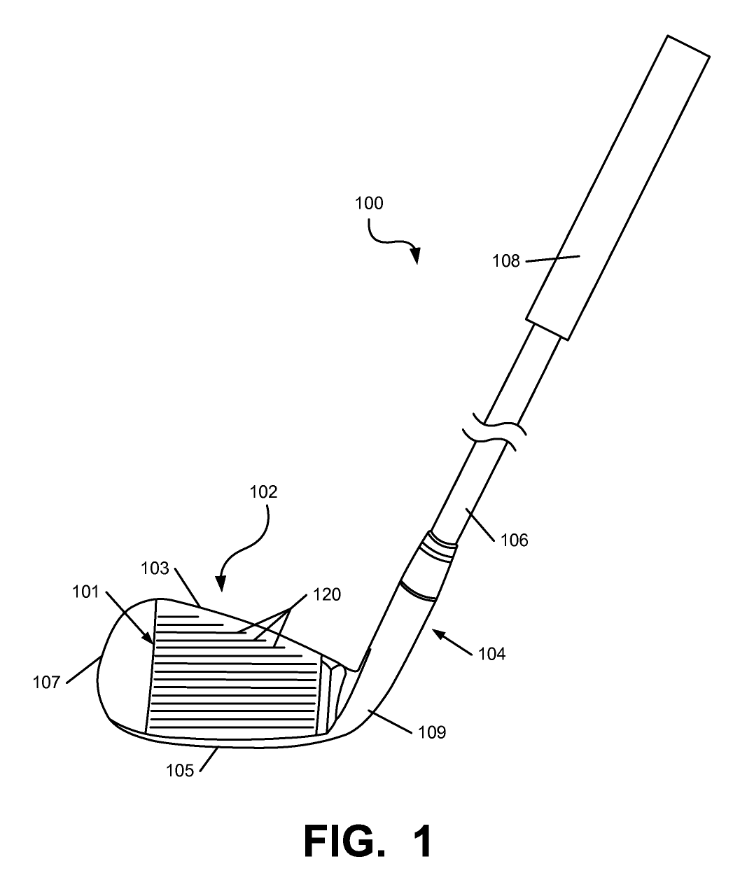

Golf club heads may generally include a plurality of different regions, segments, portions, ends, etc. In an example embodiment, a golf club head may generally include a front ball striking face, a rear, a toe, a heel, a top or crown and a sole. The golf club heads may include a single or a multiple piece construction and structure, e.g., including one or more individual parts corresponding to a sole, a front face (optionally including a ball striking surface that may be integrally formed therein or attached thereto), a top or crown, a bottom or sole, a rear, etc. If desired, various portions of the club head structure may be integrally formed with one another, as a unitary, one piece construction, without departing from the invention (e.g., the front face and/or rear may be integrally formed with the sole and/or top, etc.). Optionally, if desired, the various portions of the club head structure (such as the sole, the top, the face member, the rear, etc.) individually may be formed from multiple pieces of material without departing from this invention (e.g., a multi-piece top, a multi-piece sole, etc.). Also, as other alternatives, if desired, the entire club head may be made as a single, one piece, unitary construction, or a front face may be attached to a one piece club head rear (optionally, a hollow body, etc.). More specific examples and features of golf club heads and golf club structures according to this invention will be described in detail below in conjunction with the example golf club structures illustrated in FIGS. 1 through 8B.

FIG. 1 generally illustrates an example golf club 100 and/or golf club head 102 in accordance with this invention. In addition to the golf club head 102, the overall golf club structure 100 of this example includes a hosel 104, a shaft 106 received in and/or inserted into and/or through the hosel 104, and a grip or handle 108 attached to the shaft 106. Optionally, if desired, the external hosel 104 may be eliminated and the shaft 106 may be directly inserted into and/or otherwise attached to the head 102 (e.g., through an opening provided in the top of the club head 102, through an internal hosel (e.g., provided within an interior chamber defined by the club head 102), etc.).

The shaft 106 may be received in, engaged with, and/or attached to the club head 102 in any suitable or desired manner, including in conventional manners known and used in the art, without departing from the invention. As more specific examples, the shaft 106 may be engaged with the club head 102 via a hosel 104 and/or directly to the club head structure 102, e.g., via adhesives, cements, welding, soldering, mechanical connectors (such as threads, retaining elements, or the like), etc.; through a shaft-receiving sleeve or element extending into the club head body 102; etc. The shaft 106 also may be made from any suitable or desired materials, including conventional materials known and used in the art, such as graphite based materials, composite or other non-metal materials, steel materials (including stainless steel), aluminum materials, other metal alloy materials, polymeric materials, combinations of various materials, and the like. Also, the grip or handle 108 may be attached to, engaged with, and/or extend from the shaft 106 in any suitable or desired manner, including in conventional manners known and used in the art, e.g., using adhesives or cements; via welding, soldering, adhesives, or the like; via mechanical connectors (such as threads, retaining elements, etc.); etc. As another example, if desired, the grip or handle 108 may be integrally formed as a unitary, one-piece construction with the shaft 106. Additionally, any desired grip or handle 108 materials may be used without departing from this invention, including, for example: rubber materials, leather materials, rubber or other materials including cord or other fabric material embedded therein, polymeric materials, and the like.

The club head 102 itself also may be constructed in any suitable or desired manner and/or from any suitable or desired materials without departing from this invention, including from conventional materials and/or in conventional manners known and used in the art. For example, in the example club head 102 shown in FIG. 1, the club head 102 includes a front face 101 that generally includes a ball striking surface 102a (optionally including a ball striking face plate integrally formed with the ball striking surface 102a or attached to the club head such that the face plate and a frame together constitute the overall ball striking surface 102a). The club head 102 may further include a top surface 103, a sole 105, a toe 107 and a heel 109. The club head 102 may also include a rear (not shown in FIG. 1).

A wide variety of overall club head constructions are possible without departing from this invention. For example, if desired, some or all of the various individual parts of the club head 102 described above may be made from multiple pieces that are connected together (e.g., by welding, adhesives, or other fusing techniques; by mechanical connectors; etc.). The various parts (e.g., crown, sole, front face, rear, etc.) may be made from any desired materials and combinations of different materials, including materials that are conventionally known and used in the art, such as metal materials, including lightweight metal materials, and the like. More specific examples of suitable lightweight metal materials include steel, titanium and titanium alloys, aluminum and aluminum alloys, magnesium and magnesium alloys, etc. Additionally or alternatively, the various parts of the club head may be formed of one or more composite materials. The club head 102 also may be made by forging, casting, or other desired processes, including club head forming processes as are conventionally known and used in the art.

The various individual parts that make up a club head structure 102, if made from multiple pieces, may be engaged with one another and/or held together in any suitable or desired manner, including in conventional manners known and used in the art. For example, the various parts of the club head structure 102, such as the front face 101, ball striking surface 102a, the top 103, the sole 105, etc., may be joined and/or fixed together (directly or indirectly through intermediate members) by adhesives, cements, welding, soldering, or other bonding or finishing techniques; by mechanical connectors (such as threads, screws, nuts, bolts, or other connectors); and the like. If desired, the mating edges of various parts of the club head structure 102 may include one or more raised ribs, tabs, ledges, or other engagement elements that fit into or onto corresponding grooves, slots, surfaces, ledges, openings, or other structures provided in or on the facing side edge to which it is joined. Cements, adhesives, mechanical connectors, finishing material, or the like may be used in combination with the raised rib/groove/ledge/edge or other connecting structures described above to further help secure the various parts of the club head structure 102 together.

The dimensions and/or other characteristics of a golf club head structure according to examples of this invention may vary significantly without departing from the invention, and the dimensions may be consistent with those commonly used in the art for similar club heads and clubs.

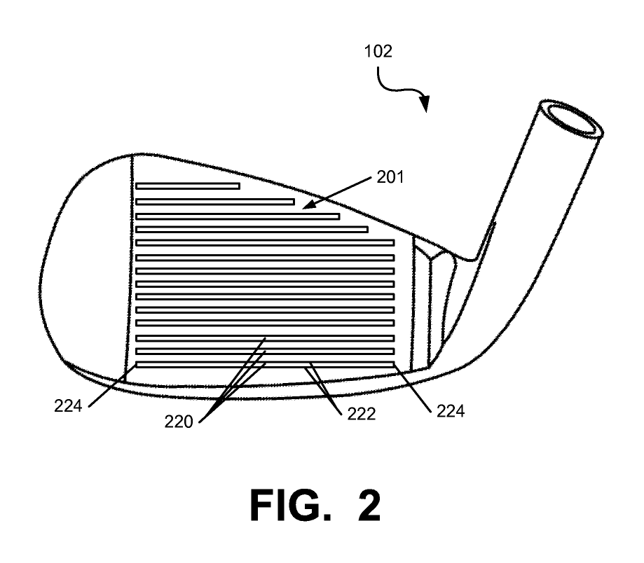

The golf club head 102 of FIG. 1 further includes a plurality of grooves 120 formed in its front face 101. These grooves 120 extend across the front face 101 in a substantially horizontal arrangement from the toe 107 to the heel 109 of the golf club head. FIG. 2 illustrates a golf club head 202 illustrating enlarged grooves 220. The grooves 220 shown in FIG. 2 may be formed in the club head 202 after manufacture of the club head 202 or front face 201 using various techniques, such as electrical discharge machining (EDM). EDM is a manufacturing process in which a desired shape is obtained by removing material from a part using a series of electrical discharges or sparks. The process is well suited to forming intricate geometries that may be difficult or impossible using conventional cutting or machining techniques. Material is removed from the part or workpiece by a series of rapidly recurring current discharges between two electrodes separated by a dielectric liquid.

There are two main types of EDM: wire EDM and die-sink EDM. In wire EDM, a continuously replaced wire is used as an electrode. In die-sink EDM, a set of electrodes having different sizes, shapes, etc. may be used during the same EDM operation in order to obtain a desired shape, configuration, surface finish, etc. In die-sink EDM, the electrode may replicate in negative the desired shape, etc. of the part and may be advanced toward the part along a single direction (e.g., along the z-axis). The electrode(s) used in die-sink EDM may have complex geometries and/or may include a series of increasingly complex geometries.

One advantage of using EDM to form the grooves 220 is that it provides a repeatable process that results in accuracy and consistency in forming various portions of the grooves 220. For instance, EDM may allow for accurate production of tight tolerances on portions of the grooves 220, such as the edge radius, as will be discussed more fully below. In addition, use of EDM in forming the grooves 220 may allow for various shapes and geometries of the grooves 220 that may be difficult or impossible to form using conventional groove manufacturing techniques, such as milling or other cutting-type machining operations, as will be discussed more fully below.

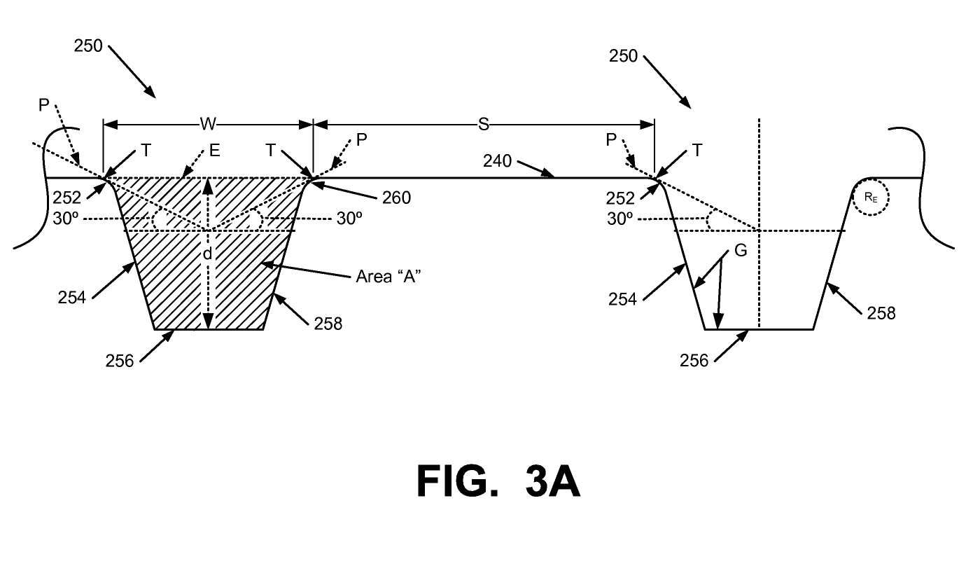

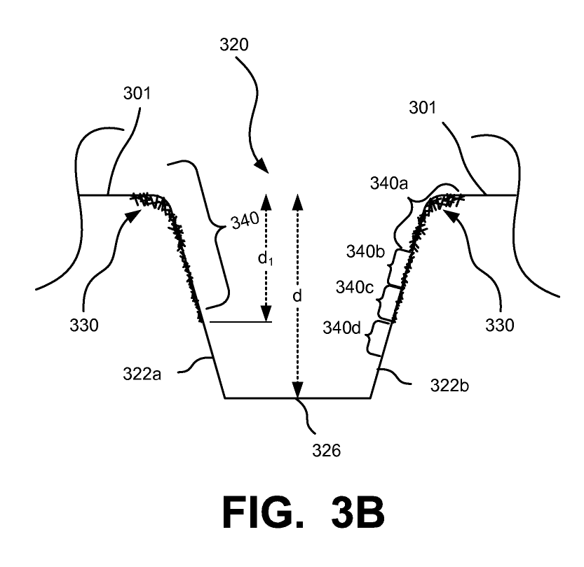

FIG. 3A is a cross sectional view of some example grooves used as an illustrative aid to explain various terms and definitions as used in this specification. FIG. 3A shows two adjacent grooves 250 on the ball striking surface 240 of an iron type golf club head (the view of FIG. 3A is looking down the longitudinal length of a groove (e.g., toward the club head toe or the club head heel). Each groove 250 of this example includes a first entry radius 252 (transitioning from the ball striking surface 240 to the groove 250 interior), a first side wall 254, a bottom wall 256, a second side wall 258 (opposite the first side wall), and a second entry radius 260 (transitioning from the ball striking surface 240 to the groove 250 interior). Consistent with Appendix II of The Rules of Golf (2010-2011) as promulgated by the USGA and as shown in FIG. 3A, the groove 250 edge is defined by a tangent point T of the groove surface G and a plane P oriented at an angle of 30° with respect to horizontal, when the club head 200 is oriented to have the ball striking surface 240 horizontal. In accordance with at least some examples of this invention, the grooves 250 may have a depth “d” of 0.075 to 0.3 inches (and in some examples, from 0.09 to 0.21 inches and even from 0.010 to 0.020 inches) and a width “W” of 0.015 to 0.035 inches (and in some examples, from 0.02 to 0.025 inches or even from 0.0205 to 02.25 inches). Further, the grooves 220 may extend from the toe 207 to the heel 209 and may be between 0.5 and 2.5 inches long (and in some examples, from 0.75 to 2.25 or even from 1.8 to 2.2 inches in length). The grooves 250 may have various cross-sectional shapes without departing from the invention, such as U-shaped, box-shaped, V-shaped, and the like. However, in many examples, the grooves 250 may have a cross-section with a bottom portion or surface 256 being narrower than the groove width W at the top or open side. For instance, the grooves 250 may have a generally trapezoidal cross-section with a top portion being open. Stated differently, the sidewalls 252 and 258 of the grooves 250 may taper toward each other as they extend from the front face 240 of the golf club head inward, toward a rear of the golf club head. That is, a bottom portion of opposing sidewalls 252 and 258 may be closer together than a top portion of the sidewalls 252 and 258.

The grooves 250 also may be separated from one another (distance “S” in FIG. 3A) by a distance between 0.075 to 0.25 inches, and in some examples, from 0.9 to 0.15 inches or even from 0.095 to 0.125 inches. The edge radii R_{E} for the a first entry radius 252 and the second entry radius 260 may be the same or different and may range from 0.0075 to 0.025 inches, and in some examples, from 0.009 to 0.021 inches or even from 0.01 to 0.02 inches.

The grooves 220 may be formed, e.g., using EDM, to have varying shapes. As shown in FIG. 2, the grooves 220 may be formed such that the open top portion is substantially rectangular (e.g., the sidewalls 222 may meet the end walls 224 at the toe and heel of each groove 220 at a substantially 90° angle along the front face 201 of the golf club head 202). Alternatively, the edges may have other shapes without departing from this invention, including tapered or sloped edges that gradually transition from one surface to the other. As some additional examples, as shown by FIG. 3A, the cross-sectional area A defined by the groove 250 (i.e., the area between the groove surface G and the extension E of the ball striking face 240 over the groove 250) may be controlled such that the following relationship is satisfied:

A/(W+S)≦0.005 in²/in.

In some more specific examples, the ratio A/(W+S) will be less than or equal to 0.004 in²/in, or even less than or equal to 0.003 in²/in. Additional aspects of the size, shape, configuration, etc. of the grooves in accordance with examples of this invention will be discussed more fully below.

FIG. 3B is a cross-sectional view of one example groove 320 in accordance with this invention formed using EDM. The groove 320 is shown in isolation and only portions of the front face 301 of the golf club head are shown in order to more clearly illustrate various features of the groove 320. Further, the groove is shown enlarged to more clearly illustrate various features of the groove 320. Also, although this cross-section is provided as an example, nothing in the specification or figures should be viewed as limiting the invention to only this example cross-section. Rather, various features of the grooves formed using EDM described herein may be implemented in grooves of varying cross-sections (e.g., U-shaped grooves, box shaped grooves, V-shaped grooves, etc.).

Groove 320 includes sidewalls 322a and 322b. As discussed above, the sidewalls 322a, 322b generally taper (e.g., the gap between the sidewalls 322a, 322b becomes narrower) as the sidewalls 322a, 322b extend inward from the front face 301 to a bottom 326 of the groove 320. Although not shown in FIG. 3B, the groove 320 includes an end wall at each longitudinal end of the groove 320 (i.e., on end located toward the club head heel and one end located toward the club head toe). In some examples, the end wall may meet the bottom 326 at a substantially 90° angle, as will be discussed more fully below.

Groove 320 further includes two edge radii 330, one at a lower edge of the groove 320 and one at the opposite, upper edge of the groove 320. Each edge radius 330 is formed as a “round” where the sidewall 322a, 322b transitions into the front face 301. Golf club manufacturers are required to meet certain edge radius guidelines in order to produce a club that conforms to USGA rules. For instance, a conforming club having a loft angle of more than 25° may have an edge radius not less than 0.010 inches and not greater than 0.02 inches (with a 0.001 inch tolerance). In some instances, forming grooves to this specification and within accepted tolerance ranges may be difficult. However, EDM provides a repeatable process of forming grooves having a conforming edge radius within the accepted tolerance ranges because it allows for small amounts of material to be removed in a tightly controlled process. Accordingly, very tight tolerances can be reproduced.

In addition, use of EDM may cause minimal if any distortion in the front face 301 during manufacture. For instance, in a conventional manufacturing process (such as forging), metal from the face is displaced when grooves are pressed into the front face 301. This displaced metal may distort the face 301, possibly necessitating further treatment to the face to assure that it is flat. With EDM, the material is physically removed using the series of electrical discharges or sparks, and thus there is less distortion in the face 301.

Groove 320 may further include a surface texture 340 formed along the edge radius 330 and, in some instances, along a portion of the sidewall 322a, 322b and/or the front face 301. In some arrangements, the texture may extend a distance d₁ along a sidewall 322a, 322b between 10% to 75% of the overall depth “d” of the groove 320 (and in some instances, between 15% and 50% or even between 20% and 30% of the overall depth d of the groove 320). In some examples, the texture may extend approximately 25% of the overall depth of the groove 320. Texture along the edge radius 330 may aid in gripping a golf ball during a golf shot (and better imparting spin), while the relatively smoother lower portion/bottom of the groove 320 may aid in channeling debris, such as water, grass, etc. out of the groove 320 and away from the club face 301 (the lack of texturing in the bottom of the groove 320 can help prevent the debris from adhering to the groove walls 322a, 322b and inhibiting its exit). The grip imparted on the ball may vary based on the swing speed of the club and/or the type of texturing of the groove and/or the ball striking face.

In some examples, the textured area 340 may have regions of varying roughness. For instance, region 340a of the texture 340 may have a first roughness, while region 340b may have a second roughness, region 340c may have a third roughness and region 340d may have a fourth roughness. In some arrangements, the texture 340 may become less rough as it extends from the edge radius 330 downward toward a bottom 326 of the groove 320. For instance, region 340a may be more rough than region 340b, which may be more rough than region 340c, which may be more rough than region 340d (which may be smooth). This arrangement may provide a transition from the roughest portion of the texture 340 to the relatively smooth lower portion of the sidewalls 322a, 322b and bottom 326 of the groove 320. Although four texture regions 340a-340d are shown in FIG. 3B (including one smooth region), more or fewer regions of texture may be formed without departing from the invention. In some examples, texture of the surface may be measured by surface roughness, Rₐ and may be, at most, 180 micro inches in one or more regions. In other examples, the surface roughness, Rₐ may be 180 micro inches or greater than 180 micro inches. Some regions may have a roughness Rₐ between, for example, 50 and 80 micro inches, while other regions may be between, for example, 100 and 120 micro inches. Still other regions may be between, for example, 150 and 180 micro inches. The above-described ranges and values are simply some example ranges and values. Other Rₐ values of the regions may be included without departing from the invention. Additionally or alternatively, in some arrangements, any crest to trough depth of the texture may be less than 0.001 inches. In other examples, the crest to trough depth may be 0.001 inches or may be greater than 0.001 inches.

Forming the groove 320 using EDM may allow for texture 340 to be formed in a repeatable manner and without distortion of the front face 301. For instance, because forming the groove 320 using EDM may be a last step in the manufacture of the golf club head, no additional machining processes will be used that may distort the head. Further, EDM and, in some instances, the use of multiple electrodes provides the ability to form texture of varying roughness along the groove 320. For instance, in some arrangements, a single electrode may be used to form texture having a varying roughness. That is, the single electrode may make multiple passes in order to form the varying textures. Additionally or alternatively, multiple electrodes may be used to form the varying textures and/or roughness.

In some examples, the texture 340 may include a hardened or “white” layer formed via the EDM process. This hardened layer may alter the metallurgical properties of the texture 340 in order to provide additional hardness, resistance to wear, etc. The white layer may be very thin and, in some examples, may be between 0.0002 and 0.0005 inches thick.

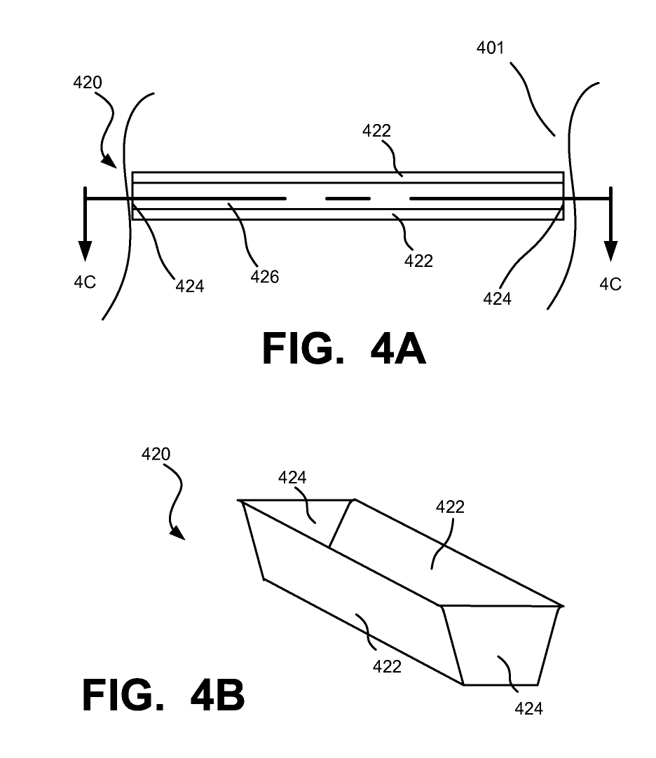

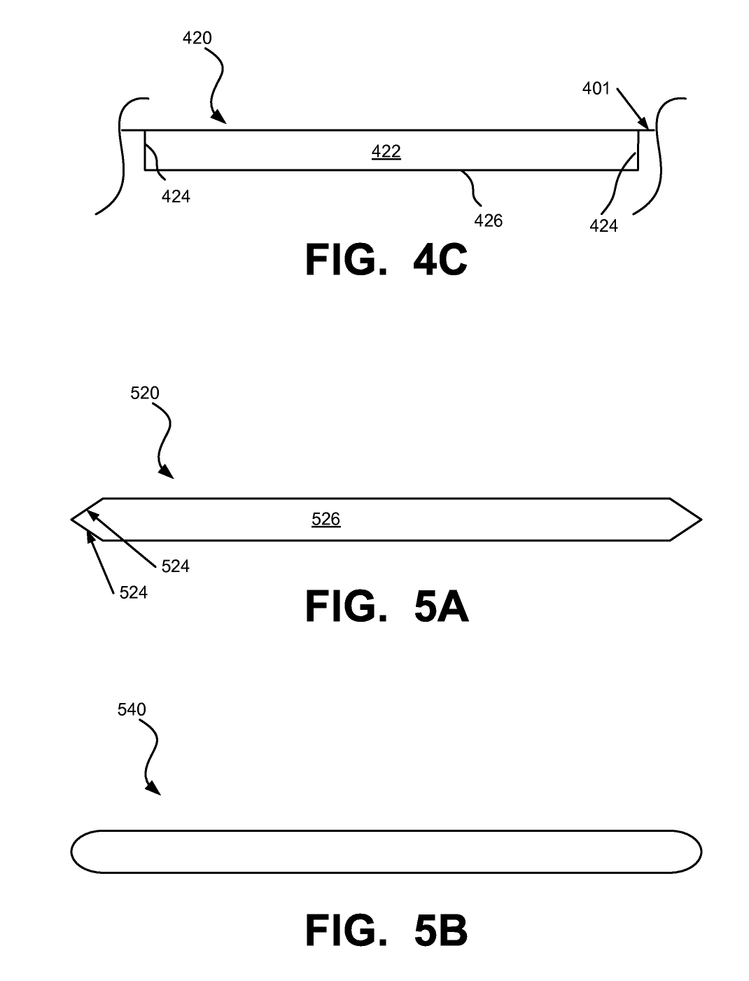

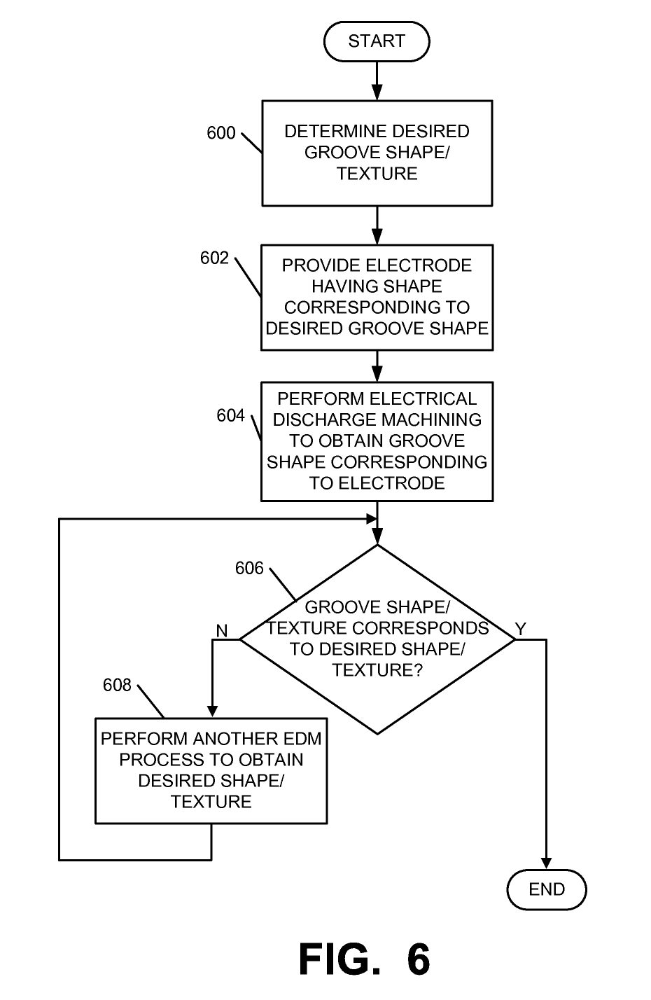

FIGS. 4A-4C illustrate one example groove arrangement formed using EDM in accordance with this invention. FIG. 4A is a front view of the groove 420. Similar to the arrangement of FIG. 3B, the groove 420 is shown in isolation and only a portion of the front face 401 of the golf club head is shown in FIGS. 4A and 4C in order to more clearly illustrate the features of the groove 420. The groove 420 includes sidewalls 422 and end walls 424. The groove 420 also includes a bottom 426. As shown, the sidewalls 422 generally taper as they extend from the front face 401 toward the bottom 426 of the groove 420. For instance, the bottom portion of the sidewalls 422 may be closer together than the top portion.

The groove 420 may be formed using EDM and, as such, may have various features that may be difficult or impossible to produce with conventional groove manufacturing techniques. For instance, in this illustrated example, the groove 420 has a generally rectangular appearance from the front, as shown in FIG. 4A. That is, the end walls 424 and sidewalls 422 meet at substantially 90° angles. Further, the end walls 424 meet the bottom 426 at substantially 90° angles. FIG. 4C is a cross-sectional view of the groove 420 taken along line 4C-4C in FIG. 4A as it extends longitudinally from the toe of the club head to the heel, and this figure illustrates the end walls 424 meeting the bottom 426 of the groove 420 at a right angle. The use of EDM in the manufacture of groove 420 may allow for repeatable production of grooves 420 having some or all of these features. Further, although groove 420 is not illustrated as including a textured portion, texture may be formed along the edge radius, sidewalls, etc. of the groove, similar to the arrangement discussed above with respect to FIG. 3B, as desired.

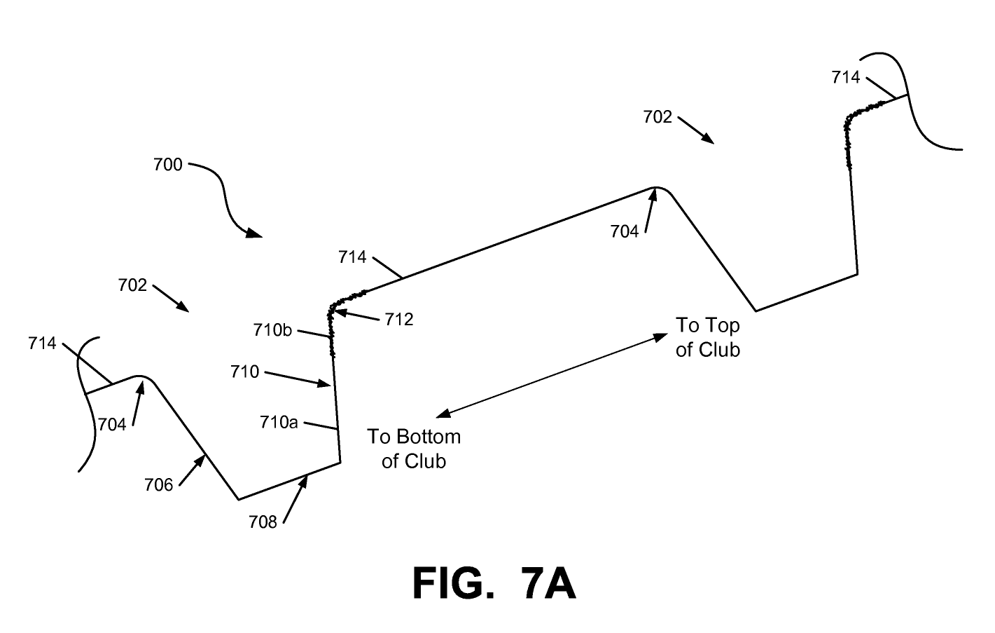

FIGS. 5A and 5B illustrate front views of additional example groove shapes that may be formed using EDM. Groove 520 in FIG. 5A includes end portions that converge to a point. This convergence to a point may extend downward to the bottom of the groove 520 (e.g., the end walls 524 may be substantially perpendicular to the bottom surface 526). Alternatively, if desired, more tapered or sloped end wall surfaces 524 may be provided. FIG. 5B illustrates a front view of a groove 540 having a substantially oval shape (which may include tapered or perpendicular side and/or end walls). Although these are two possible groove configurations, many more groove configurations are available and possible using EDM.

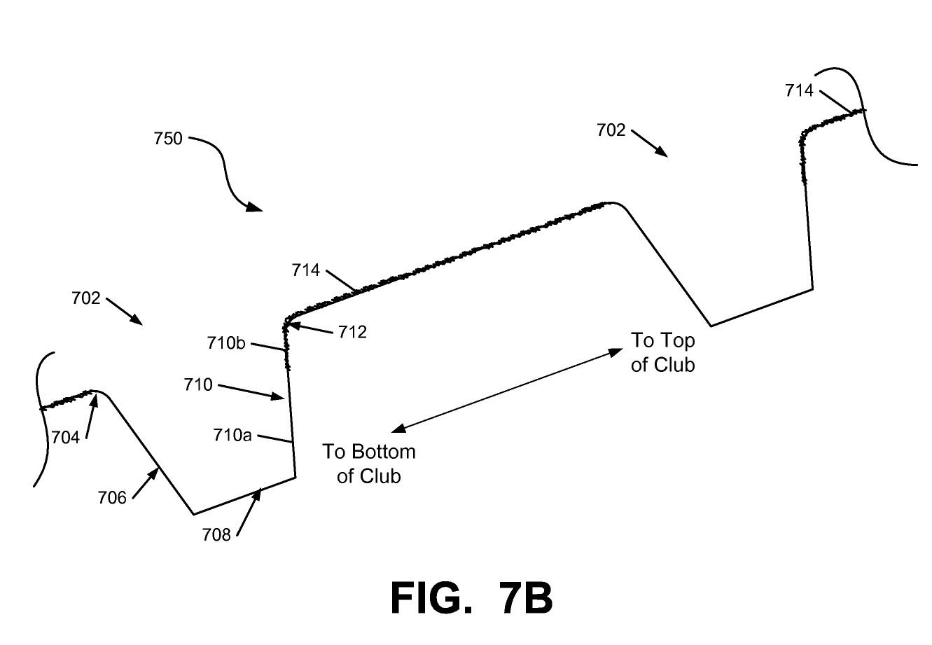

FIG. 6 illustrates one method of forming a golf club head having grooves formed using EDM. In step 600, a desired groove shape and/or texture is determined. As discussed above, grooves formed using EDM may take on a variety of shapes and configurations. Further, as discussed above, the texture may extend along the edge radius of the groove and, in some instances, down at least a portion of the sidewall and/or along the ball striking face at least part way between adjacent grooves. The roughness of the texture may vary along the length of the textured region. In some arrangements, obtaining the desired shape and texture via EDM may require more than one EDM process.

In step 602, an electrode is provided having a shape corresponding to the desired groove shape. In some instances, the electrode may be formed of graphite, copper, steel, teryllium, and the like. The material used for the electrode may be selected based on the different wear rates of the materials. In step 604, an electrical discharge machining (EDM) process is performed to form grooves having a shape corresponding to the electrode. In step 606, a determination is made as to whether the groove formed meets the desired shape and/or texture criteria. For instance, if additional texturing, or if texturing of a second roughness different from a first roughness is desired, the groove may not meet the desired texture criteria. Additionally or alternatively, if the shape of the groove does not meet the desired groove shape determined in step 600, additional EDM processes may be desired. Thus, if the groove does not meet the desired shape and/or texture criteria, a second EDM process may be performed to form the desired groove in step 608. Upon completion of this second EDM process, the groove may be reevaluated in step 606 to determine whether it meets the desired shape/texture criteria. If not, additional EDM processes may be performed in step 608. Alternatively, if the groove does meet the desired criteria in step 606, the process may end.

As noted above, groove configurations in accordance with at least some examples of this invention may include grooves having a surface in which some portions are textured (e.g., at the edge radii areas) and some portions are smooth (e.g., see FIG. 3B). Such grooves may be prepared in a variety of manners without departing from this invention. For example, if desired, a completely smooth groove structure first could be formed (e.g., using EDM or other conventional groove forming processes, like spin-milling, grinding, machining, etc.) and then, in a second step, some areas of the groove can be roughened (e.g., by roughing the edge radii and/or the ball striking surface using an EDM process, by laser ablation, etc.). As another example, if desired, a completely roughened groove structure first could be formed (e.g., using EDM, laser ablation, etc.) and then, in a second step, some areas of the groove can be smoothed (e.g., by machining the interior bottom of the groove surface to eliminate the roughened areas. Other fabrication options may be developed for producing partially smooth and partially roughened grooves without departing from this invention.

The example structure shown in FIG. 3B shows the textured areas symmetrically arranged with respect to a centerline of the groove 320. This is not a requirement in all groove structures in accordance with this invention. For example, if desired, the roughened or textured area may extend further down the sidewalls and into the groove on one side of the groove (e.g., on the top side when the club head is in the ball address position) as compared to the other side (e.g., the bottom side when the club head is in the ball address position) of the same groove. As some more specific examples, if desired, on the top sidewall of a groove, the textured area may extend up to 50% of the overall groove depth d (with smooth groove structures below that and on the bottom wall of the groove (if any)), while on the bottom side wall of the same groove, the textured area may extend only up to about 25% of the overall groove depth d (with smooth groove structures below that). Other asymmetries in the textured area extents into the groove structure are possible without departing from this invention.

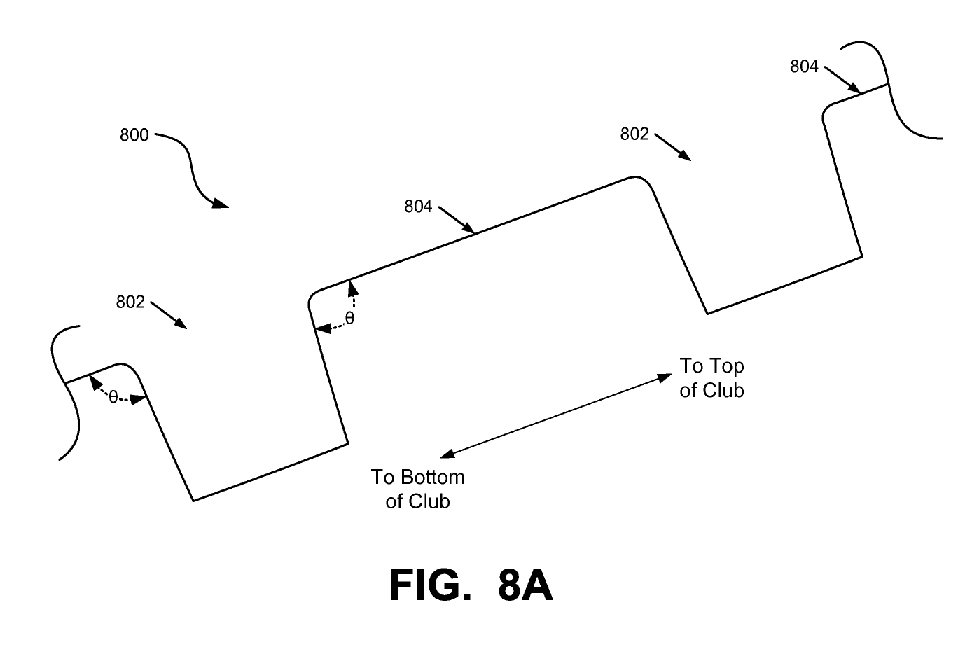

FIG. 7A shows another example cross sectional view of a groove construction 700 in accordance with at least some examples of this invention (this view is looking at two adjacent grooves, looking down their longitudinal lengths). In this arrangement, a much smaller proportion of the each individual groove 702 surface is textured. More specifically, as shown in FIG. 7A, the bottom groove entry radius 704, the bottom groove side wall 706, and the groove bottom 708 are smooth (non-textured). The top groove side wall 710, on the other hand, has a smooth portion 710a and a textured portion 710b (which may include multiple regions of different roughness, e.g., as described above, if desired). In some examples, the top groove entry radius may be vertically above the bottom groove, for instance, when the club head is in a ball address position. Furthermore, in this example structure 700, the top groove entry radius 712 and a portion of the ball striking surface 714 adjacent thereto also includes texturing. At least one adjacent groove 702 has this same type of texturing construction.

In this manner, with this construction, as the ball slides up the ball striking face 714 during a golf shot, the areas of the club face around the top edges of at least some of the grooves 702 (e.g., the top groove side wall 710 textured portion 710b, the top groove entry radius 712, and the ball striking surface 714) will tend to grab the ball and introduce backspin on the ball. The interior, bottom areas of the groove 702 remain smooth to enable easy movement of grass, water, or other debris through the grooves 702 and away from the ball.

The textured area may extend along any desired proportion of the ball striking surface 714 without departing from this invention. As shown in FIG. 7A, the textured area extends approximately 10% of the length from one top edge radius 712 to the bottom edge radius 704 of the next adjacent groove (i.e., about 10% of the overall length S from FIG. 3B). In the groove construction 750 shown in FIG. 7B, on the other hand, the textured area extends the entire length of the ball striking face surface 714, from one top edge radius 712 to the bottom edge radius 704 of the next adjacent groove 702 (i.e., 100% of the overall length S from FIG. 3B). If desired, the texturing may extend (at least somewhat) around the bottom edge radius 704 of the bottom of the next adjacent groove 702. Any desired texturing amount over this length between adjacent grooves may be provided without departing from this invention, including, for example, from 1% to 100% of the length S, and in some examples, from 5% to 100%, from 10% to 100%, or even from 25% to 100% of the length S. These same texturing extents on the ball striking face surface may be applied between grooves of the types shown in FIG. 3B without departing from this invention.

FIGS. 7A and 7B show groove configurations 700 and 750 in which the top half of each groove is treated to have texturing. Other arrangements also are possible without departing from this invention. For example, if desired, the arrangements of FIGS. 7A and 7B could be flipped such that the bottom edge radii 704 and a portion of the bottom groove side wall 706 (and optionally the adjacent portions of the ball striking surface 714) of at least some of the grooves 702 have texturing (while the top and interior-most portions of these grooves remain smooth). As another example, an individual club head may include combinations of different groove textures of these types.

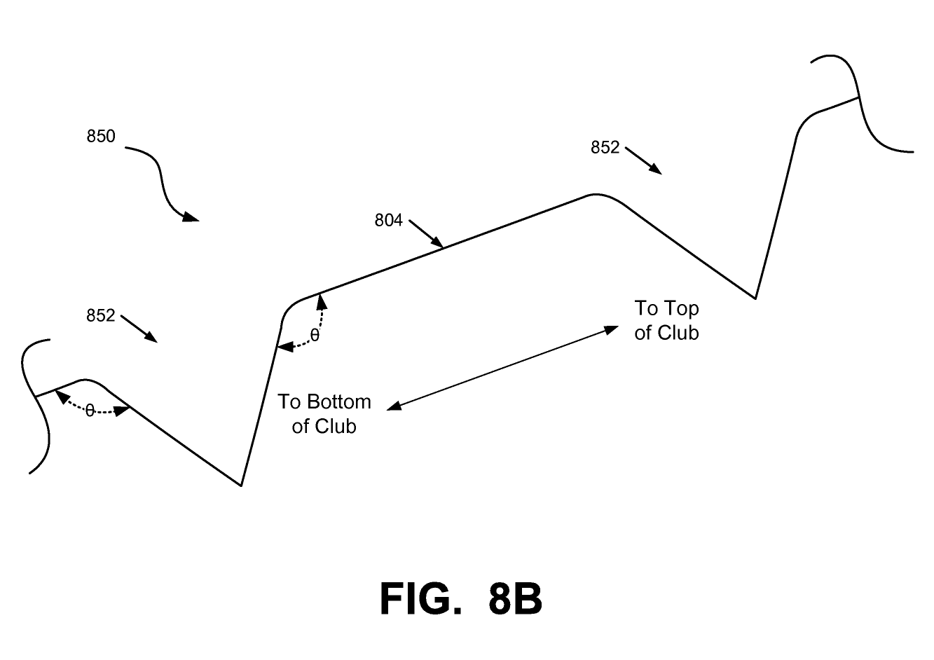

FIGS. 8A and 8B illustrate still additional groove arrangements that may be provided in accordance with at least some examples of this invention. FIG. 8A shows a groove arrangement 800 with more of a U-shaped or box-shaped groove 802 construction. FIG. 8B, on the other hand, shows a groove arrangement 850 with more of a V-shaped groove 852 construction. Any desired groove wall angles (angles θ with respect to the ball striking surface 804) may be used without departing from this invention (and the angle θ on one edge of the groove may be the same or different from the angle θ on the opposite edge of the groove). Texturing may be provided in the arrangements 800 and 850 of FIGS. 8A and 8B, respectively, in any desired manner, including in the manners described above in conjunction with FIGS. 3B, 7A, and/or 7B.

Texturing may be included in grooves and club head structures in any desired arrangements without departing from this invention. If desired, all grooves on the ball striking face of the club head, over their entire longitudinal lengths, may have texturing of the type described above (e.g., like the texturing described above in conjunction with FIGS. 3B, 7A, and/or 7B. This is not a requirement. Rather, if desired, only a portion of the longitudinal length of each groove may have texturing of the type(s) described above (e.g., the central 25% to the central 75% of each groove's longitudinal length). Also, if desired, the texturing may be continuous or discontinuous along the longitudinal length of a groove (i.e., the texturing may start and stop along the longitudinal length).

As additional examples, if desired, not every groove on the club face need include texturing like that described above. Rather, if desired, the texturing treatment can be reserved or limited to just some grooves on the club face, like every other groove as one moves from the sole to the top of the club head. As another example, the texturing treatments may be limited to the grooves located within a certain height of the overall club head, such as the bottom 4, 5, 6, or 7 grooves (or 4, 5, 6, or 7 grooves located between the uppermost groove and the lowermost groove. Any desired locations and extent of texturing may be provided without departing from this invention.

While aspects of this invention have been described for use in conjunction with confirming grooves (conforming to the new 2010 USGA groove regulations), this is not a requirement. Rather, if desired, aspects of this invention may be applied to golf club heads with any desired types of conforming or non-conforming grooves.

Any desired type of texturing may be applied to the grooves and/or ball striking face without departing from this invention. In some examples, the texturing treatment may leave a “pebbled” type surface, somewhat like the surface of a basketball or a football or the surface of a painted wall. In other instances, the texturing treatment may leave more “aggressive” sharp points or edges, to better grip the ball and impart backspin.

### CONCLUSION

While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

What is claimed is:

1. A golf club head, comprising:
a golf club head body having a front face including a ball striking surface; and
a plurality of grooves formed in the ball striking surface, the plurality of grooves being formed using electrical discharge machining (EDM), at least one groove of the plurality of grooves having a first sidewall and a second sidewall extending downward from the front face of the golf club head body to a bottom of the groove, the at least one groove further including a first edge radius extending between the first sidewall and the front face and a second edge radius extending between the second sidewall and the front face, and the first edge radius and the second edge radius including a first texture.

2. The golf club head of claim 1, wherein at least a portion of the first sidewall and at least a portion of the second sidewall include a second texture.

3. The golf club head of claim 2, wherein the first texture and the second texture have a different roughness.

4. The golf club head of claim 3, wherein the first texture is rougher than the second texture.

5. The golf club head of claim 4, wherein the first texture and the second texture extend downward along the first sidewall and the second sidewall between 20% and 30% of the overall depth of the groove.

6. The golf club head of claim 1, wherein the first texture extends from the first edge radius along at least a portion of the first sidewall and from the second edge radius along at least a portion of the second sidewall.

7. A golf club head, comprising:
a golf club head body having a ball striking surface; and
a plurality of grooves formed in the ball striking surface, at least one groove of the plurality of grooves having a first end arranged proximate the toe and a second end arranged proximate the heel, and the at least one groove of the plurality of grooves having a constant vertical depth along a length of the groove extending from the first end to the second end.

8. The golf club head of claim 7, wherein the vertical depth is measured from a top of the at least one groove proximate the front face to a bottom of the at least one groove.

9. The golf club head of claim 7, wherein the at least one groove further includes a region extending along a first sidewall and a second sidewall of the at least one groove having a texture.

10. The golf club head of claim 9, wherein the texture includes:
a first texture region along a first edge radius of the groove extending between the front face and the first sidewall and a second edge radius extending between the front face and the second sidewall, the first texture region having a first roughness;
a second texture region adjacent the first texture region and extending downward from the first texture region along the first sidewall and the second sidewall, the second texture region having a second roughness; and
a third texture region adjacent the second texture region and extending downward from the second texture region along the first sidewall and the second sidewall, the third texture region having a third roughness.

11. The golf club head of claim 10, wherein at least a portion of the first sidewall and at least a portion of the second sidewall is void of texture.

12. The golf club head of claim 11, wherein the at least a portion of the first sidewall and the at least a portion of the second sidewall void of texture are portions proximate a bottom of the groove.

13. The golf club head of claim 10, wherein the first roughness is greater than the second roughness and the second roughness is greater than the third roughness.

14. The golf club head of claim 13, wherein the texture further includes a fourth texture region adjacent the third texture region and extending downward from the third texture region along the first sidewall and the second sidewall, the fourth texture region having a fourth roughness, the third roughness being greater than the fourth roughness.

15. The golf club head of claim 7, wherein the plurality of grooves are formed using EDM.

16. The golf club head of claim 7, further including a shaft connected to the golf club head to form a golf club.

17. A golf club, comprising:
a golf club shaft;
a golf club head connected to one end of the shaft and having a golf club head body including a toe, a heel, a crown, a sole, a rear and a front face, the front face including a ball striking surface; and
a plurality of grooves formed in the ball striking surface, at least one groove of the plurality of grooves having a first sidewall, a second sidewall, a first end wall, a second end wall, and a bottom, wherein a bottom of the first end wall and a bottom of the second end wall meet the bottom of the groove at a substantially right angle.

18. The golf club of claim 17, wherein the plurality of grooves are forming using EDM.

19. The golf club of claim 17, wherein the at least one groove further includes a first edge radius extending between the first sidewall and the front face and a second edge radius extending between the second sidewall and the front face.

20. The golf club of claim 19, wherein the at least one groove further includes a texture formed along the first edge radius, the second edge radius, at least a portion of the first sidewall, and at least a portion of the second sidewall.

21. The golf club of claim 20, wherein the texture includes:
a first texture region along the first edge radius and the second edge radius, the first texture region having a first roughness;
a second texture region adjacent the first texture region and extending downward from the first texture region along the first sidewall and the second sidewall, the second texture region having a second roughness; and
a third texture region adjacent the second texture region and extending downward from the second texture region along the first sidewall and the second sidewall, the third texture region having a third roughness.

22. The golf club of claim 21, wherein the first roughness is greater than the second roughness and the second roughness is greater than the third roughness.

23. The golf club of claim 20, wherein a least a portion of the first sidewall, at least a portion of the second sidewall, and the bottom of the at least one groove are void of texture.

24. The golf club of claim 23, wherein the at least a portion of the first sidewall and the at least a portion of the second sidewall void of texture are located proximate the bottom of the at least one groove.

25. A method of forming a golf club, comprising:
forming a golf club head having a golf club head body including a toe, a heel, a crown, a sole, a rear and a front face, the front face including a ball striking surface;
forming a plurality of grooves in the ball striking surface of the golf club head body using EDM; and
connecting the golf club head to a shaft.

26. The method of claim 25, wherein the step of forming a plurality of grooves in the ball striking surface of the golf club head body further includes forming a texture along a portion of at least a first groove of the plurality of grooves.

27. The method of claim 26, wherein forming the texture includes forming a plurality of texture regions, each texture region having different texture properties.

28. The method of claim 27, wherein the different texture properties include a different roughness.

29. A method of forming a golf club, comprising:
forming a golf club head having a golf club head body including a toe, a heel, a crown, a sole, a rear and a front face, the front face including a ball striking surface;
forming a plurality of grooves in the ball striking surface of the golf club head body using EDM, wherein forming the plurality of grooves using EDM includes:
forming a first texture region using EDM, the first texture region located along an edge radius extending between the front face and a first sidewall of the groove, the first texture region having a first roughness;
forming a second texture region using EDM, the second texture region being adjacent the first texture region and extending downward from the first texture region along the first sidewall of the groove, the second texture region having a second roughness different from the first roughness; and
connecting the golf club head to a shaft.

30. The method of claim 29, wherein the first roughness is rougher than the second roughness.

31. The method of claim 29, wherein forming the first texture region and the second texture region includes forming texture along 20% to 30% of the overall depth of the groove.

32. An iron-type golf club head, comprising:
an iron-type golf club head body having a ball striking surface; and
a plurality of grooves formed in the ball striking surface, wherein at least a first groove of the plurality of grooves includes a first sidewall and a second sidewall extending inward from the ball striking surface to a bottom of the groove, the first groove further including a first edge radius extending between the first sidewall and the ball striking surface and a second edge radius extending between the second sidewall and the ball striking surface, and wherein the first edge radius includes a first texture.

33. The iron-type golf club head of claim 32, wherein the first edge radius is positioned vertically above the second edge radius.

34. The iron-type golf club head of claim 32, wherein the first texture extends between 20% and 30% of an overall depth of the first groove.

35. The iron-type golf club head of claim 32, wherein a portion of the ball striking surface adjacent the first edge radius includes the first texture.

36. The iron-type golf club head of claim 35, wherein the portion of the ball striking surface including the first texture extends 1% to 10% of a length from the first edge radius of the first groove to an edge radius of a second groove adjacent the first groove.

37. The iron-type golf club head of claim 35, wherein the portion of the ball striking surface including the first texture extends at least 10% of a length from the first edge radius of the first groove to an edge radius of a second groove adjacent the first groove.

38. The iron-type golf club head of claim 32, wherein the first edge radius is positioned vertically below the second edge radius.

39. The iron-type golf club head of claim 32, wherein the first texture includes a plurality of texture regions, at least two texture regions having different roughnesses.

40. The iron-type golf club of claim 32, wherein at least a second groove of the plurality of grooves includes a first sidewall and a second sidewall extending inward from the ball striking surface to a bottom of the second groove, the second groove further including a first edge radius extending between the first sidewall of the second groove and the ball striking surface and a second edge radius extending between the second sidewall of the second groove and the ball striking surface, wherein the first edge radius of the second groove includes the first texture, and wherein the second groove is adjacent the first groove.
